(19) United States
(12) Patent Application Publication
(10) Pub. No.: US 2008/0016264 A1
(43) Pub. Date: Jan. 17, 2008

(54) METHOD AND SYSTEM FOR HANDLING USER-DEFINED INTERRUPT REQUEST

(75) Inventor: Chen Chih-Wei, Taipei City (TW)

Correspondence Address: J C PATENTS, INC., 4 VENTURE, SUITE 250, IRVINE, CA, 92618, US

(73) Assignee: INVENTEC CORPORATION, Taipei City (TW)

(21) Appl. No.: 11/774,403

(22) Filed: Jul. 6, 2007

Related U.S. Application Data
(63) Continuation-in-part of application No. 11/133,516, filed on May 19, 2005, now abandoned.

(51) Int. Cl. G06F 13/24

(52) U.S. Cl. 710/269

(57) ABSTRACT

A method and a system for handling a user-defined interrupt request (IRQ) are provided. In the present invention, an interrupt configuration table which records the correspondence between a device ID of a first device and an interrupt handling information relates to the user-defined IRQ related to a second device is provided. When receiving the user-defined IRQ, the interrupt handling information is obtained by referring the interrupt configuration table, and a driver program corresponding to the interrupt handling information is executed in order to handle the user-defined IRQ. Since the device ID of the specific and existed device can be used for constructing the interrupt configuration table, that is to say, the redundant PCI device is no longer needed for constructing the interrupt configuration table. As a result, the hardware cost for handling the user-defined IRQ can be reduced.

### CROSS-REFERENCE TO RELATED APPLICATION

This application is a divisional application of a patent application Ser. No. 11/133,516, filed May 19, 2005, now pending. The entirety of each of the above-mentioned patent applications is hereby incorporated by reference herein and made a part of this specification.

### BACKGROUND OF THE INVENTION

1. Field of the Invention

The present invention relates to a computer hardware technology. More particularly, the present invention relates to a method and a system for handling a user-defined interrupt request (IRQ) related to peripheral devices connected to a computer system.

2. Description of Related Art

In a computer system, an interrupt request (IRQ) is issued by the peripheral device (e.g. a hard disk device, a keyboard, and a mouse) when the peripheral device needs to exchange data with the central processing unit (CPU). When receiving the interrupt request, the CPU halts the current operation temporarily so as to execute a driver program for achieving the exchange of data between the CPU and the peripheral device.

FIG. 1 is a block diagram of a conventional system for handling a user-defined IRQ. Referring to FIG. 1, a peripheral interface 130 is used for connecting an on-board device (e.g. device A 140) and a peripheral device (e.g. device B 150) to a computer system 100. Through the peripheral interface 130 and a south bridge chip 120, a processing nodule 110 (e.g. CPU) can notice the IRQ sent by the on-board device or the peripheral device.

A programmable interrupt controller (PIC) is a computer hardware architecture developed by the Intel Corporation of USA that allows the user to define a set of IRQ for the peripheral devices. In addition, an advanced programmable interrupt controller (APIC) is an advanced type of PIC that is specifically designed for using on a multi-processor based system (e.g. network server) to offer a multiplexed interrupt control function. Either the PIC or the APIC can be built in the south bridge chip 120 of the computer system 100.

In order to ensure that the user-defined IRQ related to the peripheral device can be recognized by the computer system 100, a specified system interruption line is connected to a peripheral component interconnect (PCI) device 160, wherein the PCI device 160 is used for connecting the peripheral device B 150 to the computer system 100. When the PCI device 160 receives the user-defined IRQ related to the connected device B 150, the PCI device 160 responsively issues a corresponding PCI interrupt signal so as to execute the driver program relates to the device B 150.

When the computer system 100 operates in the APIC mode, the correspondence between the device ID of the PCI device 160 and the system interruption line relates to the device B 150 has to be predefined in the MP (Multi-Processor) table or the ACPI (Advanced Configuration and Power Interface) table of the BIOS (Basic Input/Output System) as shown in FIG. 2. Referring to the interrupt configuration table 200, the fields of “Source_BUS_ID” and “Source_BUS_IRQ” are used for recording the device ID of the PCI device 160, and the fields of “Destination_IOAPIC_ID” and “Destination_IOAPIC_INTIN” are used for recording the interrupt handling information relates to the device B 150. Accordingly, by referring the table 200, the system interruption line relates to the device B 150 can be enabled by the operating system during the initiation of the computer system 100.

Consequently, in the conventional method for handling the user-defined IRQ mentioned above, for constructing the MP/ACPI table for enabling the interruption line, the PCI device is essential. Since the PCI device is typically costly to purchase, it is too dissipative to use the PCI device only for constructing the MP/ACPI table for handling the user-defined IRQ. However, without the PCI device, the interruption line corresponding to the user-defined IRQ can not be enabled, and the computer system is incapable to handle the user-defined IRQ related to the peripheral device.

### SUMMARY OF THE INVENTION

Accordingly, the present invention is directed to a method for handling a user-defined interrupt request (IRQ), which uses a specific device ID to construct an interrupt configuration table for enabling the interruption line of a computer system.

The present invention is also directed to a system for handling a user-defined IRQ corresponding to a peripheral device without a redundant PCI (Programmable Interrupt Controller) device.

As embodied and broadly described herein, the present invention provides a method for handling a user-defined IRQ, in which an interrupt configuration table is provided first, wherein the interrupt configuration table records the correspondence between a device ID of a first device and an interrupt handling information relates to the user-defined IRQ related to a second device. Then, the interrupt handling information is obtained by referring the interrupt configuration table when receiving the user-defined IRQ. Finally, a driver program corresponding to the interrupt handling information is executed for handling the user-defined IRQ.

In the method for handling the user-defined IRQ according to an embodiment of the present invention, the step of providing the interrupt configuration table further comprises obtaining the device ID of the first device, wherein the first device triggers no interrupt signal during a computer system is executed, recording the device ID of the first device and the corresponding interrupt handling information of the second device in the interrupt configuration table, loading the interrupt configuration table to a random access memory (RAM) during the process of power-on self test (POST) of the computer system, and enabling an interruption line for executing the driver program according to the interrupt handling information of the interrupt configuration table.

In the method for handling the user-defined IRQ according to an embodiment of the present invention, wherein the step of obtaining the device ID of the first device comprises determining the device ID according to a hardware specification of the computer system.

In the method for handling the user-defined IRQ according to an embodiment of the present invention, wherein the step of recording the device ID and the interrupt handling information in the interrupt configuration table comprises recording the interrupt configuration table in a read only memory (ROM) of the computer system.

In the method for handling the user-defined IRQ according to an embodiment of the present invention, wherein the first device comprises a south bridge chip.

In the method for handling the user-defined IRQ according to an embodiment of the present invention, wherein the device ID comprises a device number of the first device, a bus number and a pin number of a bus connects the first device to a computer system.

In the method for handling the user-defined IRQ according to an embodiment of the present invention, wherein the interrupt configuration table comprises a multi-processor (MP) table or an advanced configuration and power interface (ACIP) table of a basic input/output system (BIOS).

In the method for handling the user-defined IRQ according to an embodiment of the present invention, wherein the interrupt handling information comprises an interrupt handler ID and a pin number of an interrupt handler in a computer system.

In the method for handling the user-defined IRQ according to an embodiment of the present invention, wherein the second device comprises a peripheral component interconnect (PCI) device or an industry standard architecture (ISA) device.

In the method for handling the user-defined IRQ according to an embodiment of the present invention, wherein the user-defined IRQ comprises the user-defined IRQ issued by the second device.

In the method for handling the user-defined IRQ according to an embodiment of the present invention, wherein the user-defined IRQ comprises the user-defined IRQ corresponding to a specific action performed on the second device.

From another point of view, the present invention provides a system for handling a user-defined IRQ, the system comprises a storage unit, a processing module, and a driver activation module. The storage unit is suitable for recording an interrupt configuration table, wherein the interrupt configuration table records the correspondence between a device ID of a first device and an interrupt handling information relates to the user-defined IRQ related to a second device. The processing module coupled to the storage unit is suitable for obtaining the interrupt handling information by referring the interrupt configuration table when receiving the user-defined IRQ. The driver activation module coupled to the processing module is suitable for executing a driver program corresponding to the interrupt handling information to handle the user-defined IRQ.

In the system for handling the user-defined IRQ according to an embodiment of the present invention, wherein the processing module further comprises a table constructing module and a interruption line enabling module. Wherein the table constructing module is suitable for obtaining the device ID of the first device, in which the first device triggers no interrupt signal during a computer system is executed, and recording the device ID of the first device and the corresponding interrupt handling information of the second device in the interrupt configuration table. And the interruption line enabling module is suitable for loading the interrupt configuration table to a random access memory during the process of power-on self test of the computer system, and enabling an interruption line for executing the driver program according to the interrupt handling information of the interrupt configuration table.

In the system for handling the user-defined IRQ according to an embodiment of the present invention, wherein the table constructing module further comprises to determine the device ID according to a hardware specification of the computer system.

In the system for handling the user-defined IRQ according to an embodiment of the present invention, wherein the storage unit comprises a read only memory of a computer system.

In the system for handling the user-defined IRQ according to an embodiment of the present invention, wherein the first device comprises a south bridge chip.

In the system for handling the user-defined IRQ according to an embodiment of the present invention, wherein the device ID comprises a device number of the first device, a bus number and a pin number of a bus connects the first device to a computer system.

In the system for handling the user-defined IRQ according to an embodiment of the present invention, wherein the interrupt configuration table comprises a multi-processor table or an advanced configuration and power interface table of a basic input/output system.

In the system for handling the user-defined IRQ according to an embodiment of the present invention, wherein the interrupt handling information comprises an interrupt handler ID and a pin number of an interrupt handler in a computer system.

In the system for handling the user-defined IRQ according to an embodiment of the present invention, wherein the second device comprises a peripheral component interconnect device or an industry standard architecture device.

In the system for handling the user-defined IRQ according to an embodiment of the present invention, wherein the user-defined IRQ comprises the user-defined IRQ issued by the second device.

In the system for handling the user-defined IRQ according to an embodiment of the present invention, wherein the user-defined IRQ comprises the user-defined IRQ corresponding to a specific action performed on the second device.

In the method and system for handling the user-defined IRQ, the interruption line of the user-defined IRQ is enabled according to the interrupt configuration table, which records the correspondence between the specific device ID and the interrupt handling information relates to the user-defined IRQ. The specific device ID is, for example, the device ID of the specific device that triggers no interrupt signal during the computer system is executed. Consequently, the operation for handling the user-defined IRQ related to the peripheral device can be done without using any PCI device, and the cost of handling the user-defined IRQ can be reduced.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a conventional system for handling a user-defined interrupt request (IRQ).

FIG. 2 is a sketch diagram of an interrupt configuration table according to the conventional system for handling the user-defined IRQ.

FIG. 3 is a block diagram of a system for handling a user-defined interrupt request (IRQ) according to an embodiment of the present invention.

FIG. 4 is a flow chart of a method for handling the user-defined IRQ according to the embodiment of the present invention.

FIG. 5 is a flow chart of providing the interrupt configuration table according to the embodiment of the present invention.

FIG. 6 is a sketch diagram of the interrupt configuration table according to the embodiment of the present invention.

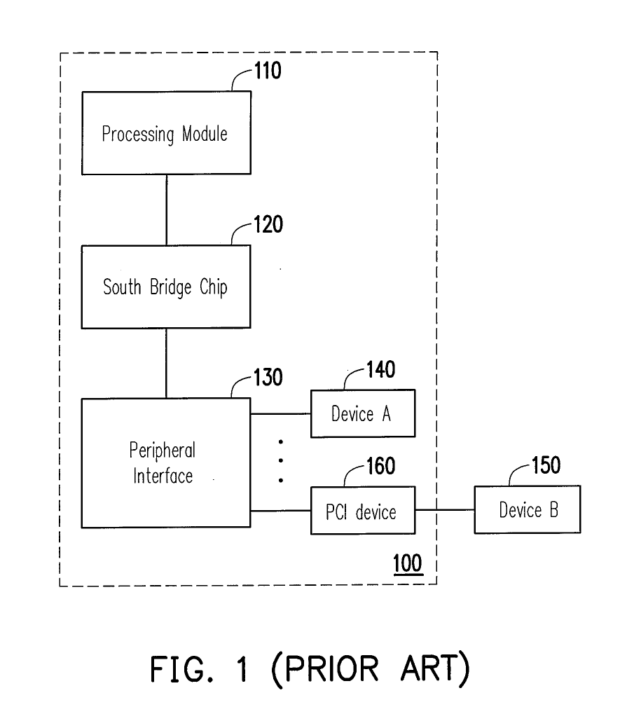

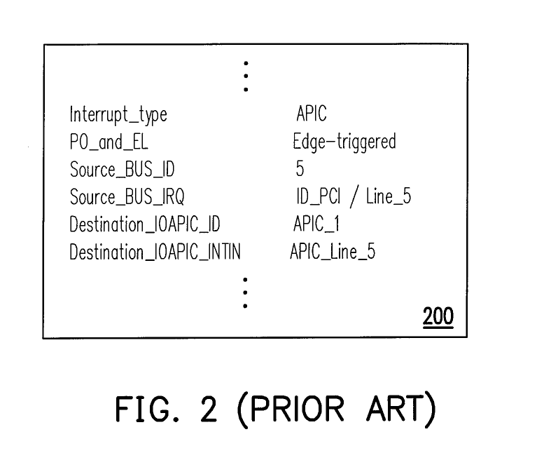

### DESCRIPTION OF EMBODIMENTS

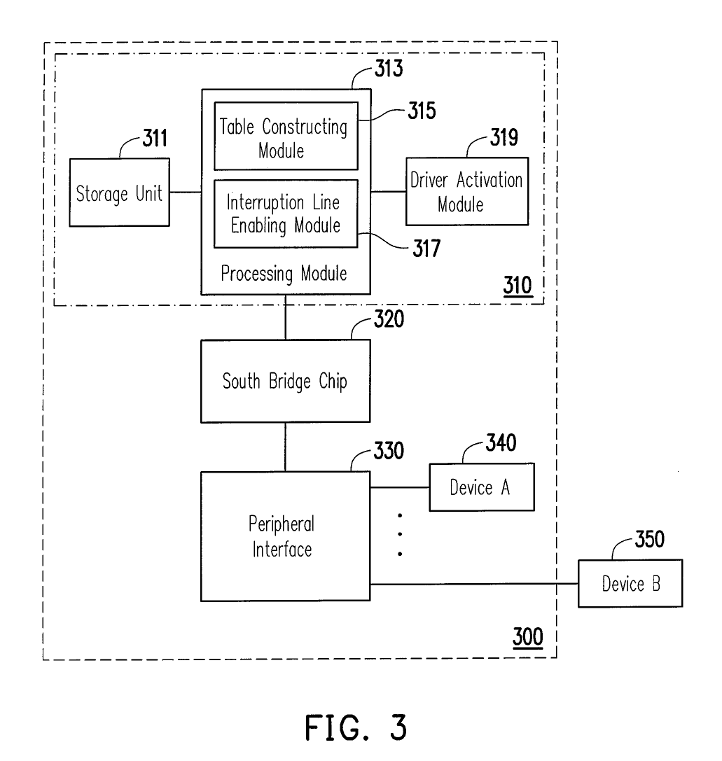

FIG. 3 is a block diagram of a system for handling a user-defined IRQ according to an embodiment of the present invention. Referring to FIG. 3, the system for handling a user-defined IRQ 310 built in a computer system 300 includes a storage unit 311, a processing module 313, and a driver activation module 319. In this embodiment, not only an on-board device (e.g. device A 340) but also a peripheral device (e.g. device B 350) can be connected with the computer system 300 through the peripheral interface 330.

The storage unit 311 is, for example, a read only memory (ROM) of the computer system 300, and is used for recording an interrupt configuration table. The interrupt configuration table records the correspondence between a device ID of a specific device (e.g. south bridge chip 320) and an interrupt handling information relates to the user-defined IRQ related to another peripheral device (e.g. device B 350). In this embodiment, the interrupt configuration table comprises a multi-processor (MP) table or an advanced configuration and power interface (ACIP) table of a basic input/output system (BIOS).

The processing module 313 coupled to the storage unit 311 is suitable for obtaining the interrupt handling information by referring the interrupt configuration table when receiving the user-defined IRQ related to the device B 350. In this embodiment, the user-defined IRQ can be issued by the device B 350, and further, the user-defined IRQ is issued after performing a specific action on the device B 350 (such as hot swapping the device B 350). The processing module 313 includes a table constructing module 315 and an interruption line enabling module 317. Wherein the table constructing module 315 is used for constructing the interrupt configuration table and recording the interrupt configuration table in the storage unit 311. The interruption line enabling module 317 loads the interrupt configuration table from the storage unit 311 to a random access memory (RAM) during the process of power-on self test (POST) of the computer system 300, and enables an interruption line for executing a driver program according to the interrupt handling information recorded in the interrupt configuration table.

As the interruption line is enabled, the driver activation module 319 coupled to the processing module 313 is suitable for executing the driver program corresponding to the interrupt handling information. Through the execution of the driver program, the user-defined IRQ related to the device B 350 can be handled properly.

The interrupt configuration table which records the correspondence between the device ID and the interrupt handling information is necessary for enabling the interruption line. Furthermore, the driver program for handling the user-defined IRQ can be executed successfully only if the interruption line is enabled. The embodiment described above takes the device ID of an existing device (e.g. the south bridge chip 320) to construct the interrupt configuration table, therefore an extra PCI device only for providing the device ID to construct the table is needless, the cost for using the extra PCI device can be saved so as to reduce the hardware cost substantially.

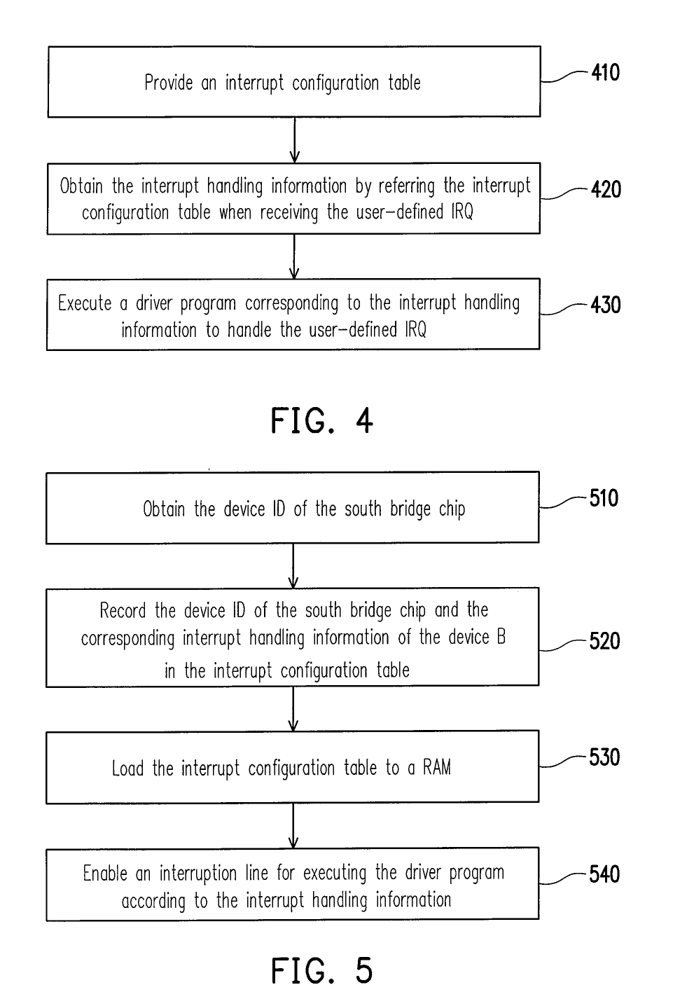

In order to illustrate the present invention in detail, the following embodiment is provided to further illustrate the operation flow of the system for handling a user-defined IRQ 310 which is built in a computer system 300. FIG. 4 is a flow chart of a method for handling the user-defined IRQ according to the embodiment of the present invention. Referring to FIG. 3 and FIG. 4, as shown in step 410, an interrupt configuration table stored in a storage unit 311 is provided first.

The details of providing the interrupt configuration table are illustrated as follows. FIG. 5 is a flow chart of providing the interrupt configuration table according to the embodiment of the present invention. Referring to FIG. 5, in step 510, a device ID of a south bridge chip 320 is obtained by a table constructing module 315 of a processing module 313. It should be further noted that, the south bridge chip 320 itself triggers no interrupt signal during the computer system 300 is executed. In this embodiment, the device ID of the south bridge chip 320 is determined according to a hardware specification of the computer system.

In step 520, the device ID of the south bridge chip 320 and a corresponding interrupt handling information of a device B 350 are recorded in the interrupt configuration table, and the interrupt configuration table is stored in the storage unit 311 by the table constructing module 315. In this embodiment, the device B 350 which issues the user-defined IRQ is, for example, a peripheral component interconnect (PCI) device or an industry standard architecture (ISA) device.

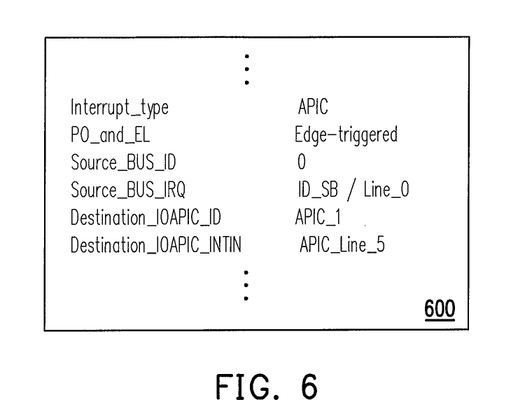

In the embodiment, the device ID comprises a device number of the south bridge chip 320, a bus number and a pin number of a bus (not shown) connects the south bridge chip 320 with the computer system 300. The interrupt handling information of the device B 350 comprises an interrupt handler ID and a pin number of an interrupt handler (not shown) in the computer system 300. As the interrupt configuration table 300 shown in FIG. 6, the device ID of the south bridge chip 320 will be recorded in the fields of “Source_BUS_ID” and “Source_BUS_IRQ”. And the interrupt handling information relates to the device B 350 will be recorded in the fields of “Destination_IOAPIC_ID” and “Destination_IOAPIC_INTIN”. The other fields of the interrupt configuration table 600 such as the field of “Interrupt_type” records the type of the user-defined IRQ, and the field of “PO_and_EL” records whether the user-defined IRQ is an edge-triggered interrupt or a level-triggered interrupt.

During the process of POST of the computer system, the interrupt configuration table stored in the storage unit 311 is loaded to the RAM by an interruption line enabling module 317 as shown in step 530. Then in step 540, according to the interrupt handling information of the interrupt configuration table, an interruption line for executing a driver program is enabled by the interruption line enabling module 317.

In this embodiment, the user-defined IRQ related to the device B 350 is issued after a specific action (e.g. hot swap or hot plug) is performed on the device B 350. Consequently, when receiving the user-defined IRQ related to the device B 350, as step 420 shown in FIG. 4, the processing module 313 obtains the interrupt handling information by referring the interrupt configuration table constructed by the table constructing module 315. Since the corresponding interruption line of the driver program is already enabled, the driver program is executed by a driver activation module 319 in step 430 so as to handle the user-defined IRQ related to the device B 350.

In view of the above, the present invention provides a method and a system for handling the user-defined IRQ. According to the above embodiments, the present invention takes the device ID of the specific and existed device to construct the interrupt configuration table for enabling the interruption line of the user-defined IRQ, wherein the device mentioned above triggers no interrupt signal. Consequently, the PCI device is no linger needed for constructing the interrupt configuration table, and the purposed of reduction the hardware cost of handling the user-defined IRQ can be achieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for handling a user-defined interrupt request (IRQ), comprising:
providing an interrupt configuration table, wherein the interrupt configuration table records the correspondence between a device ID of a first device and an interrupt handling information relates to the user-defined IRQ related to a second device;
obtaining the interrupt handling information by referring the interrupt configuration table when receiving the user-defined IRQ; and
executing a driver program corresponding to the interrupt handling information to handle the user-defined IRQ.

2. The method for handling the user-defined IRQ as claimed in claim 1, wherein the step of providing the interrupt configuration table further comprises:
obtaining the device ID of the first device, wherein the first device triggers no interrupt signal during a computer system is executed;
recording the device ID of the first device and the corresponding interrupt handling information of the second device in the interrupt configuration table;
loading the interrupt configuration table to a random access memory (RAM) during the process of power-on self test (POST) of the computer system; and
enabling an interruption line for executing the driver program according to the interrupt handling information of the interrupt configuration table.

3. The method for handling the user-defined IRQ as claimed in claim 2, wherein the step of obtaining the device ID of the first device comprises:
determining the device ID according to a hardware specification of the computer system.

4. The method for handling the user-defined IRQ as claimed in claim 2, wherein the step of recording the device ID and the interrupt handling information in the interrupt configuration table comprises:
recording the interrupt configuration table in a read only memory (ROM) of the computer system.

5. The method for handling the user-defined IRQ as claimed in claim 1, wherein the first device comprises a south bridge chip.

6. The method for handling the user-defined IRQ as claimed in claim 1, wherein the device ID comprises a device number of the first device, a bus number and a pin number of a bus connects the first device to a computer system.

7. The method for handling the user-defined IRQ as claimed in claim 1, wherein the interrupt configuration table comprises a multi-processor (MP) table or an advanced configuration and power interface (ACIP) table of a basic input/output system (BIOS).

8. The method for handling the user-defined IRQ as claimed in claim 1, wherein the interrupt handling information comprises an interrupt handler ID and a pin number of an interrupt handler in a computer system.

9. The method for handling the user-defined IRQ as claimed in claim 1, wherein the second device comprises a peripheral component interconnect (PCI) device or an industry standard architecture (ISA) device.

10. The method for handling the user-defined IRQ as claimed in claim 1, wherein the user-defined IRQ related to the second device comprises the user-defined IRQ issued by the second device.

11. The method for handling the user-defined IRQ as claimed in claim 1, wherein the user-defined IRQ related to the second device comprises the user-defined IRQ corresponding to a specific action performed on the second device.

12. A system for handling a user-defined interrupt request (IRQ), comprising:
a storage unit, suitable for recording an interrupt configuration table, wherein the interrupt configuration table records the correspondence between a device ID of a first device and an interrupt handling information relates to the user-defined IRQ related to a second device;
a processing module, coupled to the storage unit, suitable for obtaining the interrupt handling information by referring the interrupt configuration table when receiving the user-defined IRQ; and
a driver activation module, coupled to the processing module, suitable for executing a driver program corresponding to the interrupt handling information to handle the user-defined IRQ.

13. The system for handling the user-defined IRQ as claimed in claim 12, wherein the processing module further comprises:
a table constructing module, suitable for obtaining the device ID of the first device, in which the first device triggers no interrupt signal during a computer system is executed, and recording the device ID of the first device and the corresponding interrupt handling information of the second device in the interrupt configuration table; and
an interruption line enabling module, suitable for loading the interrupt configuration table to a random access memory (RAM) during the process of power-on self test (POST) of the computer system, and enabling an interruption line for executing the driver program according to the interrupt handling information of the interrupt configuration table.

14. The system for handling the user-defined IRQ as claimed in claim 13, wherein the table constructing module further comprises to determine the device ID according to a hardware specification of the computer system.

15. The system for handling the user-defined IRQ as claimed in claim 12, wherein the storage unit comprises a read only memory (ROM) of a computer system.

16. The system for handling the user-defined IRQ as claimed in claim 12, wherein the first device comprises a south bridge chip.

17. The system for handling the user-defined IRQ as claimed in claim 12, wherein the device ID comprises a device number of the first device, a bus number and a pin number of a bus connects the first device to a computer system.

18. The system for handling the user-defined IRQ as claimed in claim 12, wherein the interrupt configuration table comprises a multi-processor (MP) table or an advanced configuration and power interface (ACIP) table of a basic input/output system (BIOS).

19. The system for handling the user-defined IRQ as claimed in claim 12, wherein the interrupt handling information comprises an interrupt handler ID and a pin number of an interrupt handler in a computer system.

20. The system for handling the user-defined IRQ as claimed in claim 12, wherein the second device comprises a peripheral component interconnect (PCI) device or an industry standard architecture (ISA) device.

21. The system for handling the user-defined IRQ as claimed in claim 12, wherein the user-defined IRQ related to the second device comprises the user-defined IRQ issued by the second device.

22. The system for handling the user-defined IRQ as claimed in claim 12, wherein the user-defined IRQ related to the second device comprises the user-defined IRQ corresponding to a specific action performed on the second device.
